(19) United States
(12) Patent Application Publication
(10) Pub. No.: US 2008/0065259 A1
(43) Pub. Date: Mar. 13, 2008

(54) METHOD AND APPARATUS FOR RAPIDLY GENERATING TOOLING FOR PRESS MACHINES

(76) Inventors: David M. Dietrich, Saint Peters, MO (US); John G. Macke, Saint Charles, MO (US); Robert W. Scott, Dardenne Prairie, MO (US)

Correspondence Address: DUKE W. YEE, YEE & ASSOCIATES, P.C., P.O. BOX 802333, DALLAS, TX, 75380, US

(21) Appl. No.: 11/530,621

(22) Filed: Sep. 11, 2006

(51) Int. Cl. G06F 19/00

(52) U.S. Cl. 700/182; 700/165

(57) ABSTRACT

A method and apparatus for making a part. A digital model of the part is formed. A digital design of a tool usable to create the part is formed. The tool is created using an additive manufacturing process and the digital design of the tool. The tool is usable in a press machine to manufacture the part.

### BACKGROUND OF THE INVENTION

1. Field of the Invention

The present invention relates generally to manufacturing and in particular to a method and apparatus for creating tooling. Still more particularly, the present invention relates to a method and apparatus for rapidly creating tooling for machinery to create metal parts.

2. Description of the Related Art

A press, also referred to as a machine press, is a tool used to work metal by changing the shape and internal structure of the metal. This metal may be, for example, aluminum or steel. Bending is a typical operation performed by a machine press. This bending occurs with a machine press pressing or applying direct pressure to the material, thus forcing the material to change shape. An example of a machine press is a press brake. Machine presses may be used in a manner in which metal is placed between the plates and the plates are pressed up against each other to form the metal in the desired fashion. These plates are also referred to as dies or die plates.

When a new shape or part is required, a new die is required for use with a machine press to make the parts. Currently, conventional tooling needed to make the dies to produce the part takes approximately six to eight weeks. Currently, the tooling to create a new die requires the part to be designed. Typically, the part is designed using a computer aided design (CAD) system. Once the design has been made, a file is created for use in making the die. Next, the file from the computer aided design system is entered into a numerical control program system that converts the file from the computer aided design system into one for use in a numerical control machine that mills or cuts a steel block into a die. The numerical control program system may be a computer that converts the computer aided design file into a format for use by a numerical control machine. The output generated for the numerical control machine takes the form of data or instructions for a program that tells the numerical control machine how to remove material from a steel block to create the die. A numerical control machine is a machine that is automatically operated by commands from a processing unit. The processing unit in the numerical control machine executes a program that identifies the different coordinates for the object that is to be created.

Converting the data in a computer aided design file for a die into a form for use by a numerical control machine may take somewhere between 20 to 60 hours. Further, creating the data needed for this type of die also is expensive and time consuming. In some cases, the creation of the die may cost approximately $10,000 in addition to the 20 to 60 hours needed to create the data for a numerical control machine.

If changes are to the dies are needed, the process of revising the computer aided design file and creating a new program for the numerical control program is required. These types of changes result in more time and expense being incurred to create the tooling for the part. This process for creating a die for creating parts is both time consuming and expensive.

Therefore, it would be advantageous to have an improved method and apparatus to generate tooling for creating parts.

### SUMMARY OF THE INVENTION

An embodiment of the present invention provides a method and apparatus for making a part. A digital model of the part is formed. A digital design of a tool needed to create the part is created using an additive manufacturing process using the digital model of the tool, wherein the dies are used in a press machine to manufacture the tool.

The features, functions, and advantages can be achieved independently in various embodiments of the present invention or may be combined in yet other embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an advantageous embodiment of the present invention when read in conjunction with the accompanying drawings, wherein:

FIG. 1 is a diagram illustrating a system for creating tooling for machine presses in accordance with an advantageous embodiment of the present invention;

FIG. 2 is a diagram of a design system in accordance with an advantageous embodiment of the present invention;

FIG. 3 is a diagram illustrating components in an additive manufacturing system in accordance with an advantageous embodiment of the present invention;

FIG. 4 is a diagram of a set of dies created using fused deposition modeling in accordance with an advantageous embodiment of the present invention;

FIG. 5 is a diagram illustrating a portion of a press brake tool using dies created with an additive manufacturing process in accordance with an advantageous embodiment of the present invention; and

FIG. 6 is a diagram illustrating a process for making parts in accordance with an advantageous embodiment of the present invention.

### DETAILED DESCRIPTION OF THE PREFERRED EMBODIMENT

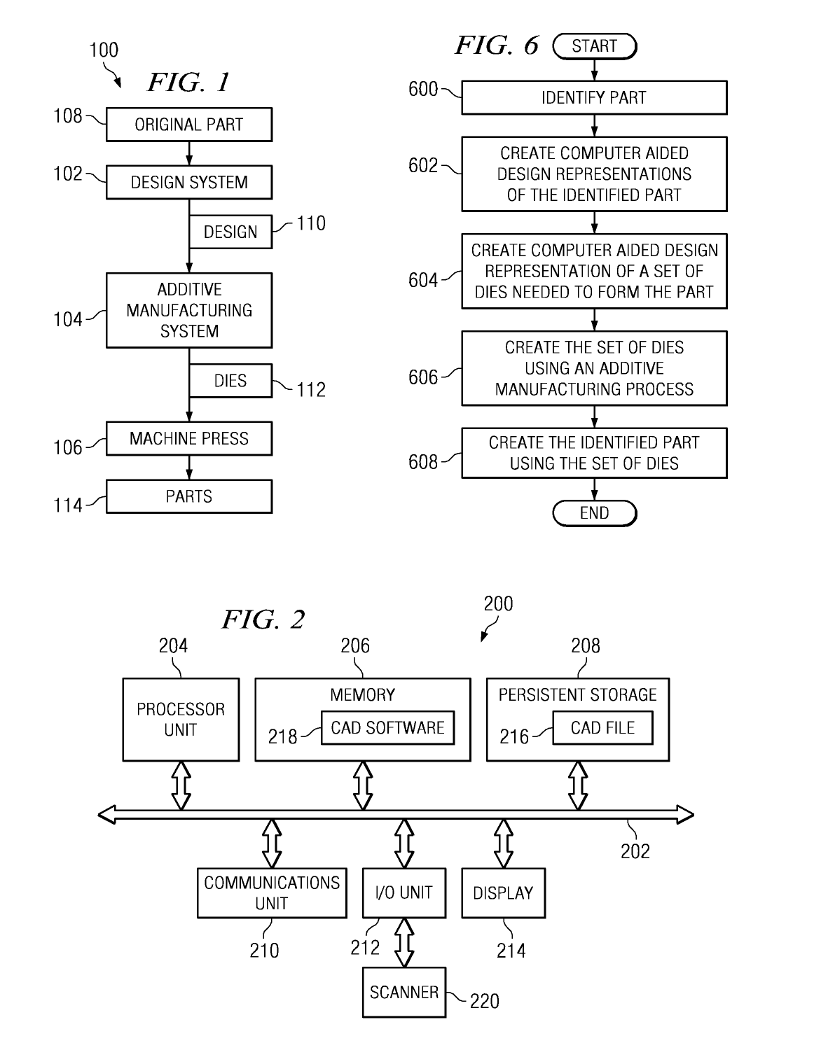

With reference now to the figures, and in particular with reference to FIG. 1, a diagram illustrating a system for creating tooling for machine presses is depicted in accordance with an advantageous embodiment of the present invention. The different embodiments recognize that the conventional process for tooling requires weeks to create rather than a day or several days. The different advantageous embodiments also recognize that one of the factors for this length of time is the time needed in currently used processes to create the data for a numerical control machine from a computer aided design file. Thus, the different embodiments employ a tool creation system that does not require the conversion of data for a numerical control machine.

System 100 contains design system 102, additive manufacturing system 104, and machine press 106. In these illustrative examples, when a new part is desired, tooling to create the part is designed using design system 102. Design system 102 provides for computer aided design. In particular, design system 102 may be a computer containing software used to design parts.

Tooling in the for of a set of one or more dies may be designed though design system 102. In this example, the dies are designed from original part 108. original part 108 may be, for example, a computer aided design file containing a digital drawing of the part. Alternatively, original part 108 may be the actual part that is scanned or digitized for use by design system 102. Alternatively, the part itself may be recreated on design system 102 from specifications for the part.

The result is design 110, which is sent to additive manufacturing system 104. Design 110 in these examples, is a file generated by the software in design system 102. This file is in a format that is useable additive manufacturing system 104. Design 110 does not have to be converted into a numerical control program as with conventional processes. The elimination of this step saves time and expense in creating tooling for a part in the advantageous embodiments described herein.

In response of receiving design 110, additive manufacturing system 104 generates dies 112. Dies 112 are the components needed by machine press 106 to generate parts 114.

Additive manufacturing system 104 forms dies 112 using design 110 from materials by adding material to create dies 112. This type of formation of dies is in contrast to currently used systems, such as systems that create dies by cutting or removing materials from a block of the materials. The additive manufacturing processing described herein is part of a rapid prototyping technology used to create new products. The illustrative embodiments use these technologies to quickly make a part. Rapid prototyping is generally used to quickly make prototypes for communication and testing purposes.

The creation of a numerical control program is avoided through the use of additive manufacturing system 104. Additive manufacturing system 104 may be implemented using a number of different technologies. In the illustrative examples, fused deposition modeling is employed in additive manufacturing system 104. Other types of additive manufacturing, such as stereolithography, selective laser sintering, and 3-D printing may be used to generate dies. The particular technology used depends on the materials available and the strength required for dies 112. For example, fused deposition modeling creates a plastic based die from a plastic filament that is unwound and heated in a nozzle that is moved in the required geometry to generate the die.

The different illustrative embodiments of the present invention also recognize that plastics are not normally used for dies. Dies are typically made of more durable materials, such as steel. However, the dies generated through this system are sufficiently durable to create parts 114. The dies made using plastic may degrade faster than dies created from metal in currently used techniques. However, these types of plastic dies are suitable for parts that require production in small numbers, such as around two, three, or ten units.

This type of limited production may arise from requests for parts for aircraft that are no longer being manufactured. These types of requests are often for limited numbers of spare parts in contrast to the numbers of parts needed for aircraft that are currently being manufactured and supported. In this manner, a request for replacement parts for a discontinued aircraft may be quickly generated at a lower cost. Examples of parts that may be created using the different advantageous embodiments are sheet metal parts. Typically, applicable parts for an aircraft are made of aluminum. These parts are currently made using a hydro-press.

The advantageous embodiments of the present invention may be used to create parts that have changing bevel angles, which are also referred to as contours. The different embodiments also may be applied to parts that have joggled flanges or parts that have standard form stiffing features. These types of stiffing features include return flanges and flange lighting holes.

Using an advantageous embodiment of the present invention, dies 112 may be created in one to two days rather than the current six to eight weeks. Further, the cost of these dies may be around $200 to $300 as opposed to around $10,000 or $15,000 for dies made using currently available process. As a result, the cost for generating a limited number of replacement parts is much lower and much more feasible than the cost of generating dies using current techniques. Thus, special tooling for these types of requests becomes feasible and results in parts that may be created for lower cost.

In addition to the ability to quickly fabricate dies 112, dies 112 may be made to fit different types of equipment used to implement machine press 106. For example, dies 112 are created to be used with machine press 106 in the form of a press brake. Typically, press brakes use wedge and v-shaped dies to bend metal to conform with tooling. The bend in the metal is made when an upper die is forced onto a lower die. Thus, press brakes are typically limited to simple shapes in creating parts from sheet metal. With the use of additive manufacturing system 104, dies 112 may be made with more sophisticated shapes to form multiple bends simultaneously.

Turning now to FIG. 2, a diagram of a design system is depicted in accordance with an advantageous embodiment of the present invention. In this example, data processing system 200 is an example of a data processing system that may be used to implement design system 102 in FIG. 1. In this illustrative example, communications fabric 202 provides communications between processor unit 204, memory 206, persistent storage 208, communications unit 210, I/O unit 212, and display 214.

Processor unit 204 serves to execute instructions for software that may be loaded into memory 206. Processor unit 204 may be a set of one or more processors or may be a multi-processor core depending on the particular implementation. Memory 206, in these examples, may be, for example, a random access memory. Persistent storage 208 may take various forms depending on the particular implementation. For example, persistent storage 208 may be, for example, a hard drive, a flash memory, a rewritable optical disk, a rewritable magnetic tape, or some combination of the above.

Communications unit 210, in these examples, provides for data exchange with other data processing systems or devices. In these examples, communications unit 210 is a network interface card. I/O unit 212 allows for input and output of data with other devices that may be connected to data processing system 200. For example, I/O unit 212 may provide a connection for user input though a keyboard and mouse. Further, I/O unit 212 may send output to a printer. Display 214 provides a mechanism to display information to a user.

In these illustrative embodiments, data processing system 200 is used to create computer aided design file 216 through the use of computer aided design software 218 loaded in to memory 206. The design generated by the use of computer aided design software 218 takes the form of computer aided design file 216 and is stored in persistent storage 208. Computer aided design file 216 may be transmitted to an additive manufacturing system to create the particular object represented in computer aided design file 216.

Further, data processing system 200 may be connected to scanner 220. Scanner 220 is a three dimensional scanner that digitizes an object for use by computer aided design software 218. Scanner 220 may be implemented using a number of different types of scanning devices. For example, scanner 220 may be a computer-tomography scanner, a laser scanner, or a touch probe scanner.

In designing a die using computer aided design software 218, a number of parameters in the model may be adjusted. In these examples, parameters were adjusted to increase the density needed from plastics used in fused deposition modeling. For example, the raster was lowered to a minimum thickness. Typically, the raster is set at 0.20 inches. In these examples, the raster was lowered to around 0.16 inches. Another parameter that is adjusted for making the die out of plastic is the depth of contour. This parameter is raised to a maximum allowable of around 0.250 inches. The parameter is normally 0.080 inches. The adjustments of these parameters reduce processing voids among the layered tool-paths within the part, thus, creating a high density part.

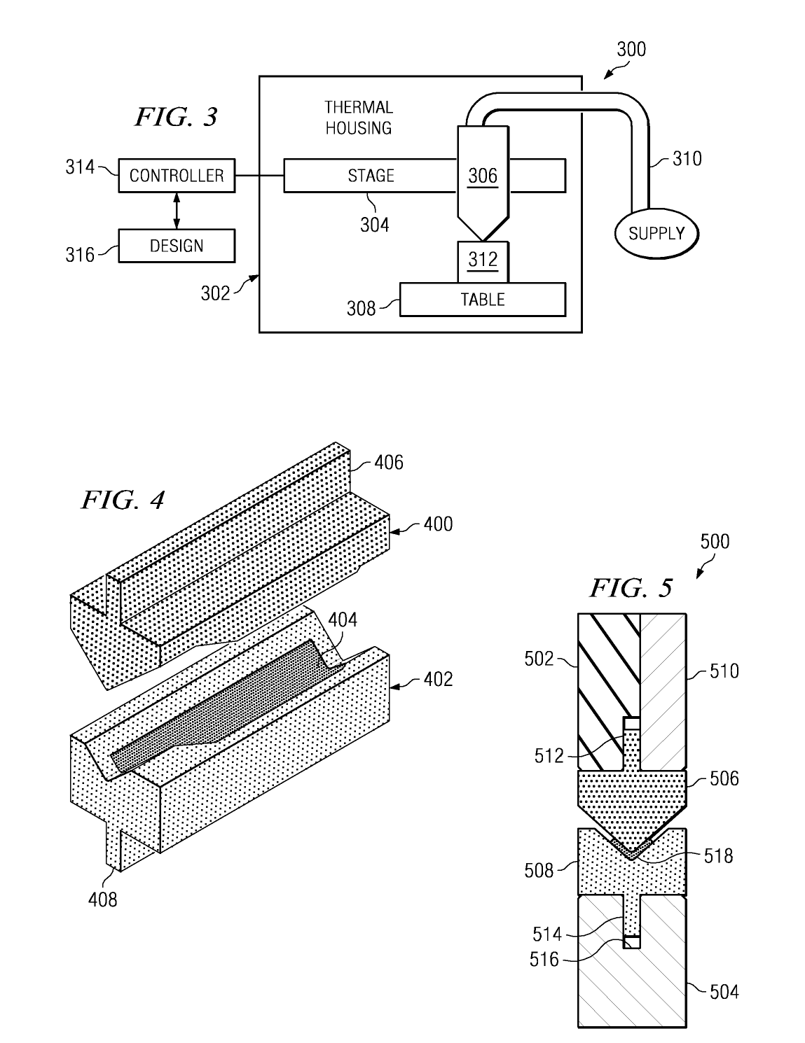

Turning now to FIG. 3, a diagram illustrating components in an additive manufacturing system is depicted in accordance with an advantageous embodiment of the present invention. In this example, fused deposition modeling system 300 is an example of a system that may be used to implement additive manufacturing system 104 in FIG. 1. In these examples, fused deposition modeling system 300 includes thermal housing 302, stage 304, nozzle 306 and table 308.

Thermal housing 302 is an oven that holds the temperature within thermal housing 302 close to, but below the melting point of plastic filament 310. In this manner, only a small additional amount of thermal energy needs to be supplied to nozzle 306 to cause the plastic in plastic filament 310 to melt. This type of temperature system also provides for better control of the process in creating an object, such as die 312.

Stage 304 is a mechanical stage that moves nozzle 306 on an x, y, and z axis to create die 312. Nozzle 306 is mounted within stage 304 and moved in x, y, and z directions as stage 304 is moved. Nozzle 306 can turn the flow of plastic onto the part being constructed on and off.

The movement of stage 304 and the heating of nozzle 306 is controlled though controller 314. Controller 314 controls the movement of stage 304 such that nozzle 306 creates layers of plastic in forming die 312 on table 308. The manner in which stage 304 is moved is controlled by controller 314 in response to design 316. In these illustrative examples, design 316 is computer aided design data from a computer aided design software such as that found on design system 102 in FIG. 1.

Die 312 is created by placing layers of plastic one on top of another on table 308. This type of manufacturing is an additive process in which layers are combined with each other to generate the object. This additive process is also referred to as computer automated manufacturing or layered manufacturing. In these examples, controller 314 slices the computer aided design model in design 316 into layers and builds those layers on table 308.

This type of manufacturing is in contrast to the commonly used processes of milling, drilling, or grinding, which are subtractive processes that remove material from a solid block. The illustrative embodiments recognize that by not needing the generation of a numerical control program for a numerical control machine, such as a lathe or drill, time and money are saved.

In these illustrative examples, the plastic used to create die 312 takes the form of plastic filament 310. Depending on the particular implementation, pellets rather than filaments may be used. The plastic used within fused deposition modeling system 300 may vary depending on the particular implementation. In these examples, a polycarbonate (PC) is employed. Other examples of materials that may be used include acrylonitrile-butadiene-styrene (ABS), ABSi, polycarbonate-ABS blend, and polyphenylsulphone. An example of equipment that may be used to implement fused deposition modeling system 300 is FDM Vantage™ SC or Stratasys Titan Ti, which are available from Stratasys, Inc.

The life of a tool, such as a die, created using fused deposition modeling may be increased by adjusting different factors. For example, the density of the plastic is one factor that may help increase the lifespan of a tool. Further, with building layers, the orientation of the part on the platform, such as table 308 also may affect the lifespan of the tool.

In these examples, a fused deposition modeling system is used; however, other types of additive manufacturing systems may be deployed depending on the particular implementation. For example, stereolithography, selective laser sintering, and 3-D printing are examples of other additive manufacturing systems that may be used to create dies in accordance with advantageous embodiments of the present invention.

Turning now to FIG. 4, a diagram of a set of dies created using fused deposition modeling is depicted in accordance with an advantageous embodiment of the present invention. In this example, top die 400 and bottom die 402 are created using an additive manufacturing system, such as fused deposition modeling system 300 in FIG. 3. These dies are generated from computer aided design files. Top die 400 contains elongated section 406. This section is used to attach top die 400 to the upper beam of a press brake. Bottom die 402 contains elongated section 408. This section is used to hold bottom die 402 in place on the lower beam of a press brake.

In these illustrative embodiments, top die 400 and bottom die 402 are made of a plastic material that has a sufficient hardness to bend a metal sheet to create formed sheet metal part 404. The type of metal used in the metal sheet may vary depending on the particular implementation. In these examples, the metal sheet is an aluminum metal sheet that is used to form sheet metal part 404. In this example, sheet metal part 404 is an aluminum part that is generally around 0.032 inches thick in a “T” condition. The different embodiments may be applied to form sheet metal parts of other varying thicknesses, such as thicknesses up to around 0.071 inches that are in the “O” condition. Common stock sizes for aircraft formed sheet meal parts are generally about 0.050, 0.063 and 0.071 inches and are traditionally formed in the “O” condition. Condition “O” is the way sheet metal comes out of the extrusion die. Condition “T” means that the sheet metal is heat treated. Steel parts having a thickness around 0.032 inches thick or less also may be formed. Of course, other thicknesses for aluminum and steel sheet metal parts, as well as other types of sheet metal parts, may be formed using other embodiments depending on the durability of the dies. Also, the sheet metal may use materials other than aluminum. For example, the sheet metal may be made of steel. The type of material and the thickness of the material depends on the ability of top die 400 and bottom die 402 to bend and shape the material without deforming or breaking these components.

Turning now to FIG. 5, a diagram illustrating a portion of a press brake tool using dies created with an additive manufacturing process is depicted in accordance with an advantageous embodiment of the present invention. In this example, press brake 500 shows components of a tool that may be used to implement machine press 106 in FIG. 1. Press brake 500 includes top anvil assembly 502 and bottom anvil assembly 504. In these examples, bottom anvil assembly 504 is stationary while top anvil assembly 502 may be moved towards or away from bottom anvil assembly 504.

As depicted, top die 506 corresponds to top die 400 in FIG. 4, while bottom die 508 corresponds to bottom die 402 in FIG. 4. Top die 506 is held in place through the use of adjustable clamp 510, which is used to clamp elongated section 512 against top anvil assembly 502. Bottom die 508 includes elongated section 514, which is held in place within groove 516 of bottom anvil assembly 504. Dies are not designed to be used with press brakes. The different advantageous embodiments employ press brakes in this manner to increase the functionality of press brakes.

In this advantageous embodiment, top die 506 is moved with respect to bottom die 508 to generate formed sheet metal part 518. In this manner, through the creation of different types of dies having different shape complexities, different types of formed sheet metal parts may be created using brake press 500. In these examples, top die 506 and bottom die 508 are created through a fused deposition modeling process as described above.

In these examples, top die 506 and bottom die 508 are composed of a plastic material formed through an additive manufacturing process in which each of the dies are created by adding successive layers of plastic in a shape that has been divided up into slices. In this manner, brake press 500 is modified to create shapes other than simple bends.

In the advantageous embodiments of the present invention, press brake 500 is implemented using a Betten Bender model 6-502. This type of press brake is a six foot long machine with a fifty ton press brake. Of course, the different embodiments may be implemented using other types of press machines other than the illustrated press brake.

The life of a tool created using fused deposition modeling for press brake 500 may be increased by adjusting different factors. For example, increasing the density of the plastic is one factor that may help increase the lifespan of a tool. Further, with building layers, the orientation of the tool on a platform, such as table 308 in FIG. 3 also may affect the lifespan of the tool.

Turning now to FIG. 6, a diagram illustrating a process for making parts is depicted in accordance with an advantageous embodiment of the present invention. The different operations in FIG. 6 are implemented using components illustrated in system 100 in FIG. 1.

The process begins by identifying a part (operation 600). The part may be identified from a request received from a customer in these examples. Computer aided design representations of the identified part are created (operation 602). These computer aided design representations may be created using engineered design definitions or specifications. Alternatively, the part itself may be scanned to get the necessary information. Next, computer aided design representations of a set of dies needed to form the identified part are created (operation 604). Operation 602 and operation 604 may be implemented in a design system, such as design system 102 in FIG. 1.

The creation of a computer aided design representation of the dies is made using the same computer aided design file created for the part. The 3D model of the die is sent to the machine implementing the additive manufacturing process. In the illustrative embodiments, the digital representation of the tool created in operation 604 takes into account spring back effects from a stamping operation. A spring back is a standard for low pressure forming. The spring back involves over forming a part by a few degrees because the material will tend to spring back or relax after the forming operation. For example, a 92 degree angle part may be formed or designed to obtain a 90 degree angle bend in the part. The amount of spring back depends on the thickness of the material, alloy, and temper. Additional factors that may affect the amount of spring back include the bend angle and the overall shape of the part. Typically, the amount of spring back is identified through trial and error to identify spring back values for different parameters.

The set of dies are created using an additive manufacturing process (operation 606). Operation 606 may be implemented using an additive manufacturing system, such as additive manufacturing system 104 in FIG. 1. Finally, the identified part is created using the set of dies (operation 608). Operation 608 may be implemented using machine press 106 in FIG. 1 in these examples.

Thus, the advantageous embodiments provide a method and apparatus for making parts. A digital model is formed or received for the part. A digital design of a tool needed to create the part is created from the digital model of the part. The tool is manufactured using an additive manufacturing process with the digital model of the tool.

The different advantageous embodiments allow for tooling to be quickly created. The time to created tooling, such as dies, may be reduced from weeks to days. Further, the cost of the tooling may be significantly less using the different advantageous embodiments of the present invention. The use of dies created from an additive manufacturing process is one feature that provides these advantages. Further, the process and system in these examples are also advantageous for limited production of parts when plastic dies are created for the tooling. In the different advantageous embodiments the digital design of the tool may be created from a digital model of the part to be manufactured. A computer aided design file for the part, specifications for the tool, or data received from scanning the part may be used to create the digital design. In these examples, the additive manufacturing process is implemented using a fused deposition modeling system. Of course, other types of additive manufacturing processes may be employed depending on the particular implementation. Further, the illustrative embodiments have been described with respect to making aircraft parts. However, the advantageous embodiments of the present invention may be applied to making other parts. For example, the processes may be applied to making parts for automobiles, trains, buildings, or boats.

Further, the different advantageous embodiments of the present invention may be applied to creating tooling other than dies as illustrated. For example, but without limitation, the different embodiments may be applied to create tooling in the form of a mandrel. The mandrel has a particular shape that is used to machine or bend an object in a selected pattern based on the shape of the mandrel.

The description of the present invention has been presented for purposes of illustration and description, and is not intended to be exhaustive or limited to the invention in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the invention, the practical application, and to enable others of ordinary skill in the art to understand the invention for various embodiments with various modifications as are suited to the particular use contemplated.

1. A method for making an aircraft part, the method comprising:
creating a first computer aided design model of the aircraft part;
creating a second computer aided design model of a set of plastic dies usable to make the aircraft part, wherein the set of plastic dies are usable in a press brake;
manufacturing the set of plastic dies using a fused deposition modeling process, wherein during manufacturing a density of the set of plastic dies is increased; and
making the aircraft part using the set of plastic dies with the press brake.

2. The method of claim 1, wherein plastic in the set of plastic dies is selected from one of polycarbonate, ABS, polycarbonate-ABS blend, or polyphenylsulphone.

3. The method of claim 1, wherein the part comprises a replacement part for a part usable in an aircraft.

4. The method of claim 1, wherein the set of plastic dies has a sufficient strength to bend sheet metal.

5. The method of claim 1, wherein the first computer aided design model is created from one of a specification for the part or a scan of the part.

6. The method of claim 1, wherein the aircraft part comprises a sheet metal part.

7. (canceled)

8. A method for making a part, the method comprising:
forming a digital design of a tool usable to create the part and
manufacturing the tool using an additive manufacturing process and the digital design of the tool, wherein during manufacturing a density of the tool is increased, and wherein the tool is usable in a press machine to make the part.

9. The method of claim 8, wherein the additive manufacturing process comprises a fused deposition modeling process.

10. The method of claim 8, wherein forming comprises:
scanning the part to create a three-dimensional representation of the part; and
creating the digital design of the tool from the three-dimensional representation of the part.

11. The method of claim 10, wherein scanning comprises:
scanning the part with a laser scanner to form the three-dimensional representation of the part.

12. The method of claim 8, wherein the tool comprises a set of plastic dies.

13. The method of claim 8, wherein the tool comprises a mandrel.

14. The method of claim 8, wherein the part comprises an aircraft part.

15. (canceled)

16. The method of claim 8, wherein the press machine comprises a press brake and wherein the tool comprises a set of dies.

17. (canceled)

18. (canceled)

19. An apparatus for manufacturing a part, the apparatus comprising:
a data processing system, wherein the data processing system generates a computer aided design model of a tool; and
an additive manufacturing system in communication with the data processing system, wherein the additive manufacturing system creates the tool using the computer aided design model, wherein while creating the tool a density of the tool is increased, and wherein the tool is usable to manufacture the part.

20. The apparatus of claim 19 further comprising:
press equipment, wherein the press equipment uses the tool to manufacture the part.

21. The apparatus of claim 20 wherein the press equipment comprises a press brake and wherein the tool comprises a top die designed to be held in place in a top anvil assembly of the press brake and a bottom die designed to be held in place in a bottom anvil assembly of the press brake.

22. The method of claim 1 further comprising:
adjusting the second computer aided design model to take into account spring back effects from operation of the press brake.

23. The method of claim 8 further comprising:
adjusting the digital design to take into account spring back effects from operation of the press machine.

24. The apparatus of claim 19 wherein the data processing system adjusts the computer aided design model to take into account spring back effects from a stamping operation used to manufacture the part.
